(19) United States
(12) Patent Application Publication
(10) Pub. No.: US 2001/0054026 A1
(43) Pub. Date: Dec. 20, 2001

(54) Method of and system for monitoring an application

(76) Inventor: Timothy Choate, Murfreesboro, TN (US)

Correspondence Address: DICKSTEIN SHAPIRO MORIN & OSHINSKY LLP, Eric Oliver, 2101 L Street NW, Washington, DC, 20037-1526, US

(21) Appl. No.: 09/791,728

(22) Filed: Feb. 26, 2001

Related U.S. Application Data
(60) Provisional application No. 60/185,051, filed on Feb. 25, 2000.

(51) Int. Cl. G06F 17/60

(52) U.S. Cl. 705/52; 709/224

(57) ABSTRACT

A preferred embodiment of the invention provides an Application Metering method (and corresponding system) for monitoring usage of an Application (e.g., software program, content file, component, product, etc.) anywhere on a Network. In accordance with a preferred embodiment, an Application Beacon can be used in or in conjunction with an Application to make a Tagged Application. Upon activation of the Tagged Application the Beacon effectuates transmission of Application Information from the Tagged Application to an Application Metering Module. A preferred embodiment of the invention provides a method (and corresponding system) for compensating Application Developers according to usage of an Application by monitoring usage of an Application based on Application Information and Deployment Information compiled by a Billing Module. The Billing Module may invoice or extract payment from end users and provide compensation to Application Developers (or to producers or other distributors of the Application).

This application claims the benefit of U.S. Provisional Application No. 60/185,051, filed Feb. 25, 2000.

### BACKGROUND

Unlike most products, software is especially susceptible to piracy and theft. Generally, content files and other software are easy to copy and transfer from machine to machine. While producers, distributors, and manufacturers of such content files or software products have employed various mechanisms to reduce or eliminate piracy, monitoring the usage of their products remains a daunting task. Automating the sale of content/software over the Internet has both decreased the transaction costs associated with distribution while simultaneously increasing opportunities for piracy. Users can purchase a content file, software program, or other “Application” online, download it immediately and readily distribute the Application to others via e-mail or postings on Web sites. Application developers are searching for a suitable licensing model to reduce or eliminate piracy while offering a variety of license terms to meet particular needs. A large company may wish to purchase a site license at a lower per-user cost while a small company may only need a few licenses. Users may only wish to purchase a license that permits use of the application for a defined period of time such as a month-to-month or one-year subscription.

The popularity of the distribution of Applications in the form of music and video content files over the Internet has increased exponentially through services such as Napster, and Web sites such as E-music, MP3.com and other Internet sites. Traditionally, the music industry licensed content and monitored compliance through organizations such as BMI and ASCAP. These organizations offer a variety of blanket license arrangements. However, monitoring compliance with the license agreement is not automated. Monitoring the usage of a music or video file on the Internet poses a greater challenge for content owners since a music or video file can be distributed en masse by anyone with access to the Internet.

### SUMMARY

A preferred embodiment of the invention provides an Application Metering method (and corresponding system) for monitoring usage of an Application (e.g., software program, content file, component, product, etc.) anywhere on a Network. In accordance with a preferred embodiment, an Application Beacon can be used in or in conjunction with an Application to make a Tagged Application. Upon activation of the Tagged Application the Beacon effectuates transmission of Application Information from the Tagged Application to an Application Metering Module.

A preferred embodiment of the invention provides a method (and corresponding system) for compensating Application Developers according to usage of an Application by monitoring usage of an Application based on Application Information and Deployment Information compiled by a Billing Module. The Billing Module may invoice or extract payment from end users and provide compensation to Application Developers (or to producers or other distributors of the Application).

### BRIEF DESCRIPTION OF THE DRAWINGS

FIG. 1 is a block diagram illustrating an exemplary system in accordance with a preferred embodiment of the invention.

FIGS. 2 and 3 collectively depict the process flow of an exemplary system in accordance with a preferred embodiment of the invention.

FIG. 4 illustrates an exemplary implementation of a preferred embodiment of the invention.

### DETAILED DESCRIPTION OF PREFERRED EMBODIMENTS

Preferred embodiments and applications of the invention will now be described herein. Other embodiments may be realized and structural or logical changes may be made to the disclosed embodiments without departing from the spirit or scope of the invention. Although preferred embodiments of the invention are particularly described as applied to software application development, it should be readily apparent that the invention may be embodied in any file or content monitoring method, open-source process, or other environment having the same or similar problems.

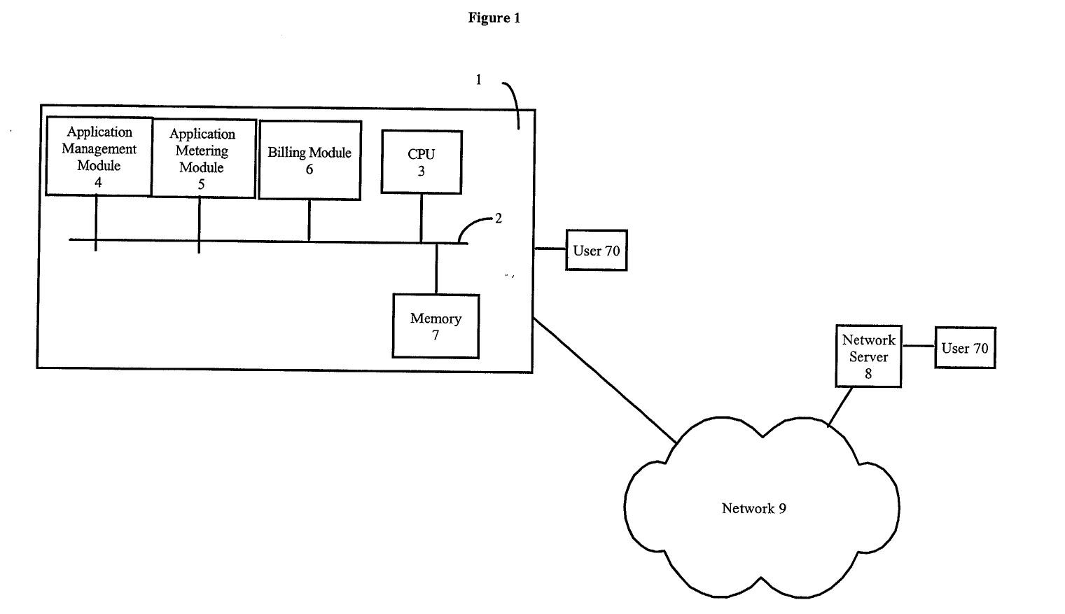

The system illustrated in FIG. 1 is composed of an application Server 1 for implementing the monitoring operations described below in accordance with preferred embodiments of the invention. (It should be apparent, however, that many, if not all, of the operations may be implemented using alternative devices and architectures.) In accordance with a preferred embodiment, Server 1 may include one or more central processing units (CPUs) symbolically represented by CPU 3 used to provide processing of input/output data between Server 1, User Interface 70, and/or Network 9, and among the different modules (all connected together via system bus 2) within Server 1. CPU 3 typically executes one or more computer programs stored in the one or more memory devices symbolically represented as memory module 7.

User interface 70 provides one or more display devices (e.g., CRT, LCD, or other known displays) and one or more input/output devices (e.g., touch screen interface, keyboard, mouse, stylus, push button, lever, or other known input mechanisms) for facilitating the input and output of information to the system by a user through User Interface 70. Network 9 may take any wired/wireless form of known connective technology (e.g., internal LAN, enterprise WAN, intranet, Internet, Virtual Private Network (VPN), etc.) to allow Server 1 to provide local/remote information and control data to/from other locations. In accordance with a preferred embodiment of the invention, the server may be implemented in stand-alone or network devices, as well as serving one or more users over a collection of remote and disparate networks (e.g., Internet, intranet, VPN, etc.).

The system described above and illustrated in FIG. 1 may be used to effectuate any one or more aspects of the monitoring operations described in (and apparent from) the specific embodiments, implementations, and illustrations provided herein.

In accordance with a preferred embodiment, the system may be provided to facilitate monitoring the deployment and/or usage of an Application (e.g., executable software, data source files, etc.) on Network 9. An Application Management Module 4 may be provided to receive Applications, embed an Application Beacon in an Application forming a Tagged Application, and deploying the Tagged Application to any desired location on or off the Network 9.

Application Metering Module 5 is provided to receive Application Information from the Tagged Application, monitor deployment and/or usage of the Tagged Application, and transmit the received Deployment Information (that may include the Application Information, statistical deployment/usage information, etc.) to any desired location on or off Network 9.

In accordance with a preferred embodiment, the Tagged Application utilizes the Beacon to transmit Application Information to Application Metering Module 5. The Application Information may include information regarding the deployment (e.g., installation details, etc.) and/or usage (e.g., how many licensed users operating a program, etc.) of the Tagged Application in a particular user environment (e.g., on a personal computer, mainframe, local area network, etc.). The Application Information may be sent to Application Metering Module 5 using one or more data packets (or other communication forms) in any suitable format or protocol (e.g., Simple Mail Transfer Protocol (SMTP), etc.). The Application Information may be sent to Application Metering Module 5 periodically or in real time, upon installation and/or at specific intervals or events that best monitor use of a given Application (e.g., daily, weekly, monthly, upon log-on, based on predetermined conditions, etc.).

In another preferred embodiment, a Billing Module 6 may be provided to compile Application and Deployment Information and disburse payment to any desired party (e.g., producer, developer, publisher, wholesaler, retailer, etc.) based on the information compiled.

Preferably, CPU 3 performs, controls, or at least informs the various processing steps performed by the system. (One or more of the modules in Server 1 may utilize its own (or another) CPU or other processing device to effectuate its own functions and operations.)

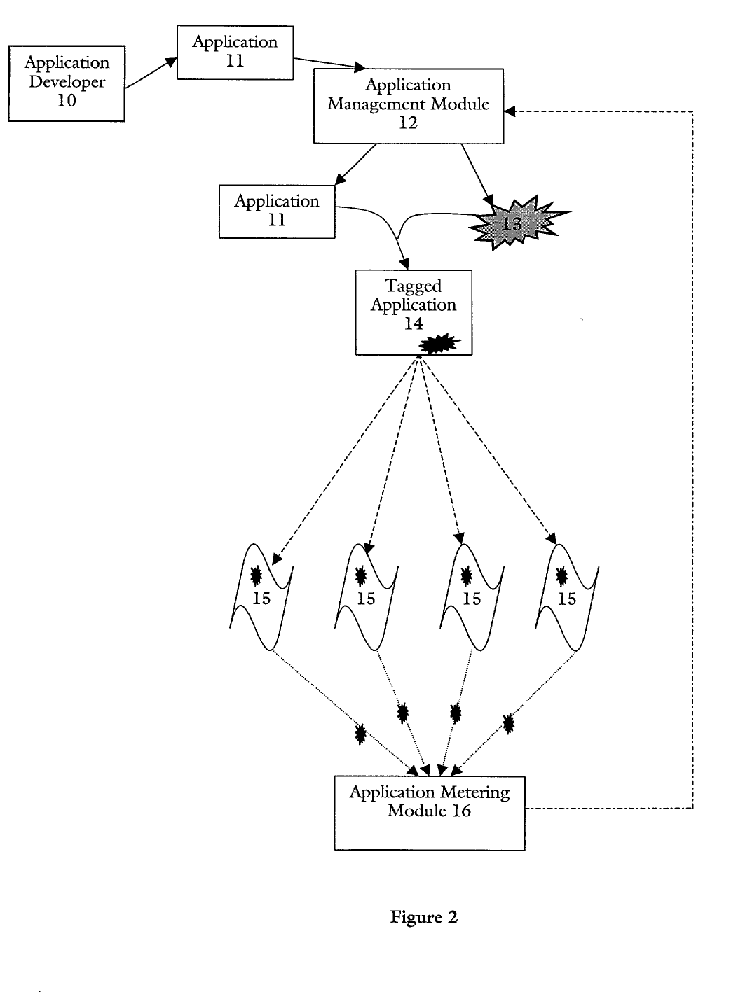

FIG. 2 illustrates a typical operational flow of an Application to be monitored in accordance with a preferred embodiment of the invention. As shown, an Application Developer 10 (or other provider of an Application) provides an Application 11 to an Application Management Module 12. The Application Management Module 12 embeds (or provides for embedding) an Application Beacon 13 in Application 11 forming Tagged Application 14.

Tagged Application 14 may be distributed by any suitable mechanism (e.g., retailer, wholesaler, direct seller, given away, etc.) to one or a plurality of users represented by User Workstations 15 for deployment or other installation to prepare Tagged Application 14 for activation and use. The Tagged Application 14 may be activated by a variety of mechanisms including, but not limited to, obtaining an Application Key from a remote server, installation of the Application on a User Workstation 15 or remotely over the network. When activated, the Beacon in the Tagged Application 14 can transmit Application Information to the Application Metering Module 16 over a network (or through any other communication system).

The Application Information transmitted may include any information regarding deployment and/or usage of the Tagged Application (e.g., configuration of the Application or system used, the number of users of an Application, the number of workstations where the Application is installed, the length of time an Application has resided on a workstation, the amount of time an Application has been used on a workstation or group of workstations, etc.). The Application Information may be transmitted in any suitable format or protocol (e.g., SMTP, TCP/IP, WAP, etc.) as may be dictated by the medium and means used to communicate the Application Information. The Application Information may be further sent, together with Deployment Information to Application Management Module 12 for storage and/or transmission to any desired destination on or off the network (e.g., the Application Developer 10, etc.). When an Tagged Application is implemented on a computer workstation that is not persistently connected to a network, for example, the Tagged Application may be monitored when the computer workstation connects to the network. When the computer workstation initiates a connection to the network, the Application Information (e.g., formatted into a SMTP data packet) can be automatically sent to the Application Metering Module 16.

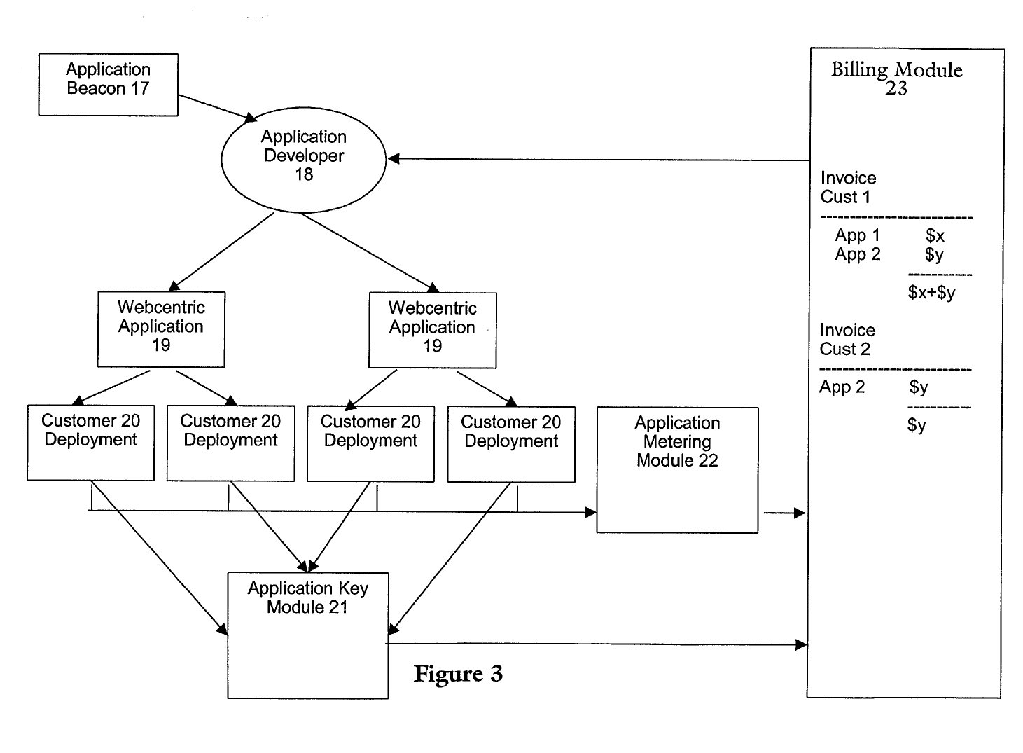

FIG. 3 depicts a preferred embodiment of the invention wherein an Application Beacon 17 is provided to an Application Developer 18 and embedded in a plurality of Applications forming Tagged Applications 19. Tagged Applications 19 are deployed by a plurality of Customers 20. In this exemplary embodiment, customers 20 obtain from Application Key Module 21 an Application Key to activate the Application. If Customers 20 pay a license or other fee in order to obtain the Application Key from Application Key Module 21, Application Key Module 21 may transmit such payment information to Billing Module 23 (or other accounting module). Upon activation of the Tagged Applications utilizing the Application Key, the Beacon within Tagged Application 19 transmits Application Information to Application Metering Module 22.

Application Metering Module 22 receives the Application Information and performs any necessary processing (e.g., generating statistics, analysis, etc.) on the Application Information before transmitting Deployment Information (which may include the Application Information) to Billing Module 23. The Billing Module 23 compiles the Deployment Information and, where appropriate, disburses payment to any desired party (e.g., Application Developer 18) in accordance with payment criteria.

To further illustrate the structure and operation of preferred embodiments of the invention, the following exemplary implementations of preferred embodiments are provided.

### EXAMPLE 1

### The Application Value Chain

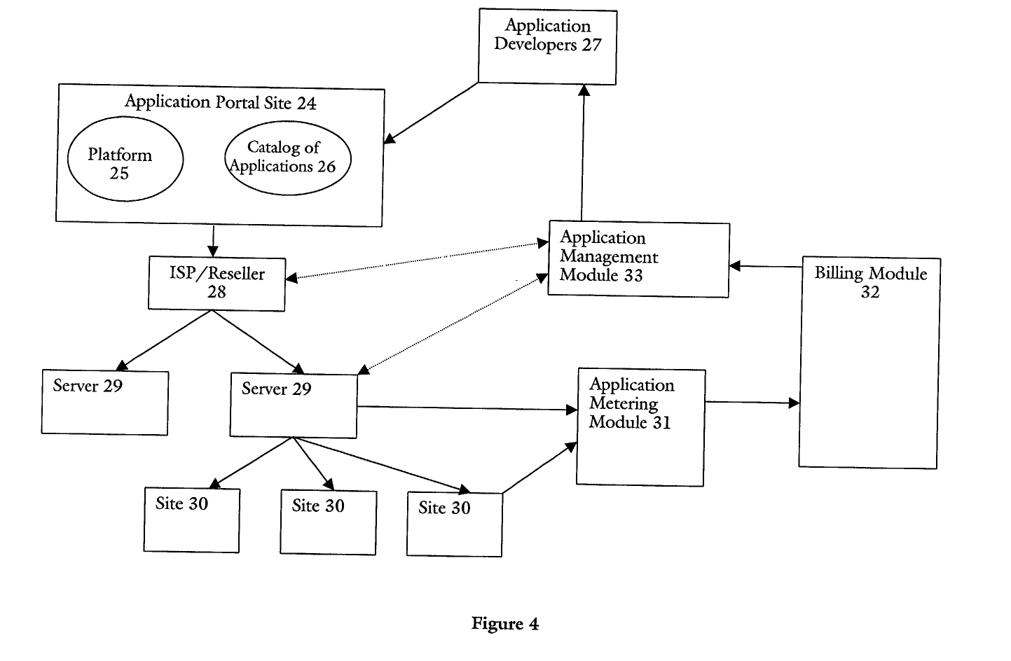

An Application Value Chain may be provided as shown in FIG. 4 implementing a preferred embodiment of the invention. The Application Value Chain provides a superior licensing, tracking, and royalty distribution system for use with digital assets or Applications (e.g., software applications, etc.) on the Internet. Application Management Module 33 may be provided to supply application developers with technologies for application development and access to an established distribution network.

The application value chain is facilitated by the use of one or more channels of distribution for individual Applications created by application developers. In this exemplary implementation, an Application Portal Site 24 is provided for distribution of Applications within its Catalog of Applications 26. Application Portal Site 24 may cater to developers specializing in one or more Platforms 25 (e.g., any TCP/IP compatible platform such as EdgeNet Application Server Environment (EASE), Java/JSP, Cold Fusion, PHP, Native Language (C, C++, VB), Linux, etc.).

As shown in FIG. 4, Application Developers 27 (e.g., independent software developers, small software companies creating Web-centric applications, companies creating open source code, etc.) contribute Applications to Catalog 26 for distribution of the Applications on Application Portal Site 24. Applications in the Catalog are “tagged” with Beacons added by the Developers 27 (or by Site 24 or others) prior to being included in Catalog 26. In this exemplary embodiment, the Beacons are in the form of API source code provided by Application Management Module 33 (or by Site 24 or other sources) to Developers 27 for inclusion in the Applications.

In this exemplary implementation, the Applications are Web-centric software applications that run on (or in conjunction with) the Internet. Customers or users of the Applications download the desired Application(s) from Application Portal Site 24 and run them on (or in conjunction with) individual Servers 29. In this exemplary implementation, the Beacon restricts the use of the Application until the Application is licensed and a unique key generated.

Although the Application Management Module 33, Application Developers 27, or other entities may provide the necessary unlocking code, the customer or user is illustrated in FIG. 4 as making an e-commerce payment through Server 29 to Application Portal Site 24 for licensing and the unlock key generation.

Once unlocked, the Applications that will be used on Server 29 become active and a data file containing Application Information is transmitted from the Beacon from each Application activated. The Application Information is transmitted via e-mail (or other communication paths) to the Application Management Module 33. The received Application Information contains basic information (e.g., IP address, etc.) about Server 29, including any database name used, any licensed applications that will be running on Server 29, and other information specific to Server 29 and/or the customer or user. Using the IP address (or other identifying information), the Application Metering Module is able to track activity (e.g., deployment, usage, etc.) and transmit Deployment Information to the Billing Module 32 and/or to Application Management Module 33, which measures software deployment and/or usage at the application and user levels.

This information is stored in the Application Metering Module 31 and forwarded to the Billing Module 32 for generating billing information. The billing information is transmitted to the Application Management Module and payment may be disbursed to the Application Developers 27 in accordance with the usage of the Applications made by customers or users through Servers 29.

### EXAMPLE 2

### Metering Usage of Content Files on the Internet

Another exemplary commercial implementation of a preferred embodiment of the invention involves an Application in the form of some specific content (“content file”) such as a music, video, image file in any known format (e.g., CD-Audio, MP3, MPEG, JPEG, etc.). Such content files (and/or the players of the content files) are embedded with an Application Beacon to allow deployment of the content files (and players) anywhere on the Internet (e.g., a Web site, in an e-mail attachment, newsgroup, etc.). A customer desiring to download, stream, or locally play the content file purchases an Application Key from an Application Key Server to unlock the content file, if required. The content file owner can designate a price for the Application Key based on the level of access desired by the customer. For example, a customer may wish to purchase unlimited access to the content file or pay on a per-stream or play basis. Whenever the Tagged Content file is downloaded, streamed, or played, Application Information is sent by the Beacon (e.g., from a local processor executing Beacon software, from the audio/video player itself (i.e., Real Audio Player, Windows Media Player, etc.)) to the Application Metering Module to monitor usage of the Tagged Content file anywhere on the Internet. The Application Information and corresponding Deployment Information can be compiled by an Application Management Module and/or Billing Module to monitor and compensate the producers/distributors of the content file according to any desired formula.

While preferred embodiments have been specifically described and illustrated herein, it should be apparent that many modifications to the embodiments and implementations of the invention can be made without departing from the spirit or scope of the invention. For example, while the methods and systems of preferred embodiments of the invention may have been specifically illustrated as applied to an Application (e.g., application program) executed on a computer persistently connected to a network (e.g., in the form of the Internet), it should be apparent that the invention may easily be embodied in Applications running on computers or other processor-based devices that may only be periodically connected (directly or indirectly) with a network. The invention, for example, may be embodied to monitor Applications running on (or used in conjunction with) individual ones of a plurality of devices (e.g., network/stand-alone personal computers, personal digital assistants (PDAs), WebTV (or other Internet-only) terminals, set-top boxes, cellular/PCS phones, screenphones, pagers, kiosks, or other known (wired or wireless) communication devices, as well as devices and appliances having embedded programs and applications).

Moreover, although the Applications and Beacons as used in the preferred embodiments described herein were illustrated in the form of executable software code or data source files, it should be apparent that the invention may be readily applied to Applications and/or Beacons implemented as hardware for monitoring the usage of Applications in accordance with the teachings provided herein. For example, a Beacon can be incorporated as hardware in a PDA cradle to transmit Application Information whenever a PDA having stored therein (or otherwise utilizing) a Tagged Application is placed in the cradle and is connected to the Internet (via a computer or wireless modem, for example). The Applications may be distributed for use by single or multi-user customer in a stand-alone environment, on one or more networks, or as supplied by an Application Service Provider (ASP) for restricted use based on agreed upon terms (e.g., time, usage, etc.).

The modules described herein may be one or more hardware, software, or hybrid components residing in (or distributed among) one or more local or remote computer systems. It should be readily apparent that the modules may be combined or further separated into a variety of different components, sharing different resources (including processing units, memory, clock devices, software routines, etc.) as required for the particular implementation of the embodiments disclosed herein. Indeed, even a single general purpose computer executing a computer program stored on a recording medium to produce the functionality and any other memory devices referred to herein may be utilized to implement the illustrated embodiments.

One or more modules (or functions therein) may be omitted partially or completely where the functions are unnecessary or otherwise supplanted. Application Management Module 4 (FIG. 1), for example, may be implemented without the functions of embedding an Application Beacon in an Application and deploying the Tagged Application to desired locations. Instead, an Application can become a Tagged Application through operation of another module in Server 1, or any other mechanism on or off Network 9, including through the developer of the Application itself (whether or not done during original coding of the Application or as an after-market, value added patch coding). The Tagged Application may be deployed or otherwise distributed utilizing any retail, wholesale, direct sales, or other known distribution channels without interaction with Server 1.

The Application Management Module 4, Application Metering Module 5, and Billing Module 6 may be independently operable by different computer systems on different servers, within different networks (or even completely omitted) without detracting from the operations described herein.

User interface devices utilized by methods and systems of the invention may be any device used to input and/or output information. The interface devices may be implemented as a graphical user interface (GUI) containing a display or the like, or may be a link to other user input/output devices known in the art.

While the illustrated embodiments have not specified the type of communication medium (or protocol) used to connect the various modules (e.g., shown in FIG. 1), it should be apparent that any known wired/wireless technology may be used to implement the invention (e.g., Internet, intranets, private bulletin boards, individual local or wide area networks, proprietary chat rooms, ICQ, IRC channels, instant messaging systems, WAP, bluetooth, etc.) using real-time or non-real-time systems alone or in combination.

In addition, memory units employed by the system may be any one or more of the known storage devices (e.g., Random Access Memory (RAM), Read Only Memory (ROM), hard disk drive (HDD), floppy drive, zip drive, compact disk-ROM, DVD, bubble memory, etc.), and may also be one or more memory devices embedded within a CPU, or shared with one or more of the other components.

What is claimed as new and desired to be protected by Letters Patent of the United States is:

1. A method of monitoring the usage of an application on a network, the method comprising:
associating an application beacon with an application to form a tagged application;
activating said application beacon in said tagged application; and
transmitting application information concerning usage of said tagged application.

2. The method of claim 1, wherein said tagged application is activated upon installation of said tagged application.

3. The method of claim 2, wherein said tagged application is a software application activated by an application key upon installation of the software application.

4. The method of claim 3, wherein said associating step comprises:
receiving executable code for use in transmitting application information during usage of the application; and
embedding the executable code in the application.

5. The method of claim 1, wherein said transmitting step comprises transmitting application information from said tagged application to an application management module.

6. The method of claim 5, wherein said transmitting step is performed periodically to periodically update the application management module of the usage of said tagged application.

7. The method of claim 5, wherein said application information is transmitted using data packets in Simple Mail Transport Protocol (SMTP) format.

8. The method of claim 1, wherein the application information includes the number of users of an application, and the amount of time a user of an application operates said tagged application.

9. The method of claim 1 wherein said network is the Internet, and the application is a content file containing audio and video information.

10. A system for monitoring the usage of a software application on a network, the system comprising:
an application management module, coupled to the network, wherein said application management module supplies at least one application beacon for embedding in a software application; and
an application metering module, coupled to the network, wherein said application metering module receives application information concerning usage of the software application on the network.

11. A system for monitoring the usage of an application, the system comprising:
a processing unit; and
a memory, wherein a computer program is stored in said memory for execution by said processing unit to embed a beacon in an application, and transmit application information concerning usage of the application.

12. A method of compensating application developers according to usage of an application, the method comprising:
embedding an application beacon in an application to make a tagged application;
activating said tagged application;
transmitting application information concerning usage of the application;
monitoring usage of said application; and
compensating an application developer according to usage of said application.

13. The method of claim 12, further comprising transmitting the application information to an application billing module wherein a payment amount is calculated for each application according to usage of said application.

14. A method of monitoring the usage of a content file on a network, the method comprising:
embedding an application beacon in a content file to form a tagged content file;
transmitting application information concerning usage of the tagged content file in response to the application beacon; and
compensating a content file owner according to usage of the tagged content file.

15. The method of claim 14, further comprising executing the application beacon in a player used to read the tagged content file so as to perform said transmitting step upon each playing of the tagged content file.

16. The method of claim 15, wherein said tagged content file contains at least one of an audio file in an MP3 format, a video file in MPEG format, a graphics file in JPEG format.

17. A system for monitoring usage of an application on a network, wherein the application is embedded with a beacon in the form of API source code to form a tagged application, the system comprising:
a portal Web site, wherein said portal Web site stores and distributes to customers applications for application developers;
a customer server comprising:
a processing unit; and
a memory, wherein a computer program is stored in said memory for execution by said processing unit to download a tagged application from said portal Web site, activate the tagged application using an application key, utilize the beacon to generate application information comprising an IP address and the number of users of said tagged application, and transmit the application information using data packets in Simple Mail Transport Protocol (SMTP);
an application metering module receiving application information from said customer server, wherein said application metering module compiles statistics regarding deployment and usage of said tagged application, and outputs deployment information containing the application information; and
a billing module receiving the deployment information from said application metering module, wherein said billing module associates the deployment information with one of a plurality of application developers and issues payment to an associated one of the application developers in accordance with a predetermined schedule.

18. The system of claim 17 wherein said network is the Internet.

19. The system of claim 17 wherein said billing module calculates the number of days a user accesses a tagged application and compares said number of days a user accesses a tagged application to the number of days a user is permitted to access an application.

20. The system of claim 17, wherein said billing module calculates a payment to an application a developer according to usage of said tagged application.
